(19) United States
(12) Patent Application Publication
(10) Pub. No.: US 2016/0364695 A1
(43) Pub. Date: Dec. 15, 2016

(54) Method and System for Cloud-based Predictive Analytics in Support of Family Interactions

(71) Applicant: Kerri Patterson, Carrboro, NC (US)

(72) Inventor: Kerri Patterson, Carrboro, NC (US)

(21) Appl. No.: 15/180,206

(22) Filed: Jun. 13, 2016

Related U.S. Application Data
(60) Provisional application No. 62/175,678, filed on Jun. 15, 2015.

(51) Int. Cl. G06Q 10/10; H04L 29/06; H04L 12/26; H04L 29/08; G06N 3/00

(52) U.S. Cl. CPC G06Q 10/1093; H04L 67/10; G06N 3/006; H04L 43/0876; H04L 65/4076

(57) ABSTRACT

This document presents a system and method that takes data from multiple sources that can be input by a family user and/or collected on behalf of the family user; then leveraging latent and active analytics and predictive learning. The system and method aggregates each piece to deliver content determined by the end user to optimize time, streamline content, send reminders, manage multiple calendars and minimize disruption through a single sign-on customizable dashboard that tells each user in a family organization when and where they need to be engaged.

### PRIORITY CLAIM

This Non-Provisional application claims under 35 U.S.C. §120, the benefit of priority to Provisional Application 62/175,678, filed Jun. 15, 2015, titled “Method and System for Cloud-based Predictive Analytics in Support of Family Interactions”, which is hereby incorporated by reference in its entirety.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

The present invention relates generally to the social environment and tracking of activities in a family group and environment. Families are busier than ever in these times and the ability to coordinate between family members is often accomplished between several social media, smart devices, and even old-fashioned means such as landline phone calls. Reducing stress in interactions and fostering communication is a goal of many types of social media websites and smart device applications and the welter of communication channels can be overwhelming.

The sheer number of social media communication applications can lead to a loss of communications when each member of a group, such as a family, uses a different application to communicate. These lost messages and interactions can lead to increased stress, rather than lowering stress levels because of introduced scheduling conflicts and mis-communication.

Tracking data and analysis of captured information associated with family communications and scheduling also require a level of security that is not commonly seen with groups on existing social media websites and mobile applications.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of the My Family Cloud application dashboard consistent with certain embodiments of the present invention.

FIG. 1A is a view of the My Family Cloud application dashboard asset management display consistent with certain embodiments of the present invention.

FIG. 2 is a view of a display of the My Family Cloud application on a mobile device consistent with certain embodiments of the present invention.

FIG. 3 is a view of the family message board initial display consistent with certain embodiments of the present invention.

FIG. 3A is a view of the family message board task list display consistent with certain embodiments of the present invention.

FIG. 4 is a view of the family message board individual task list display consistent with certain embodiments of the present invention.

FIG. 5 is a view of the family message board menu and shopping list components consistent with certain embodiments of the present invention.

FIG. 6 is a view of the calendar and slider components consistent with certain embodiments of the present invention.

FIG. 7 is a view of the pet schedule information display connector adaptor consistent with certain embodiments of the present invention.

FIG. 8 is a view of the pet information record display consistent with certain embodiments of the present invention.

FIG. 9 is a view of the automobile information record display consistent with certain embodiments of the present invention.

FIG. 10 is a view of the home information record display consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The My Family Cloud application receives data from multiple sources that may be input by a user or input on behalf of a user. The collected information is aggregated and processed through latent and active analytics tools to deliver to content pre-established to be of interest and value to a user. The aggregated content permits the user to optimize time and improve communication between users in a group, such as a family group. The content is streamlined to optimize the user experience by sending reminders, managing multiple calendars for members of the group by informing members of the group when and where they need to be engaged.

The information is presented to identified members of a group through a dashboard of functions that are available to the members of the group, such as a family. Data aggregated into the My Family Cloud database is stored in secure cloud storage and links into the information permit seamless data exchange between areas of functionality. This data interchange permits data records to contain information that is aggregated for each member of the family group, and to deliver and display data, such as scheduling data, planning data, and to-do list data, to each member of the family group, fostering communication between family group members and optimizing the social interaction between members of the family group.

The My Family Cloud application is optimized for use on devices such as desktop and laptop computers, and is usable on mobile and hand held devices such as tablets, internet computers, iPads, smartphones and all such electronic communication devices. Each implementation of the My Family Cloud application, whether active on a laptop or other computer or a mobile device, presents a user with an initial message board display. This display, the family message board, serves as the initial portal into the application and permits the user accessing the My Family Cloud application to select the data or function in which the user is interested. Selection of a particular function or data display switches the application view from the family message board display to the function or data display requested.

The My Family Cloud (MFC) application architecture encompasses several categories of data elements, each of which contributes to foster communication, planning and task assessment and assignment between family members in each particular family group. Information records collected, maintained, and managed by the My Family Cloud application are associated with Assets and/or People defined to the system. In an exemplary embodiment, major categories of information records encompass Assets, People, To-Dos, Lists, and Announcements. In an embodiment, Plans are defined to the system as multiple To-Dos OR'ed with single To-Dos and Lists.

In an exemplary embodiment, Assets are data constructs that may need action provided by people in the form of To-Dos. Each of these Assets have records associated with each Assets such as, in a non-limiting example, records scheduling To-Dos via a calendar entry or reminder, create, push and pull via To-Dos or plans, push to service provider via notifications and/or Application Programming Interfaces (APIs), and information records that may record warranties, titles, sales records, service records, and loans, among others. Assets require information regarding type, age and location for each To-Do and may request information regarding records and the repository for such records.

In this embodiment, MFC may provide links between People and Information records. These links permit the MFC application to store records, review and track history, protect and restrict information access, modify, remove and transfer to locations outside of the Family group records associated with the Family group. The MFC application autogenerates plans based on Assets information, suggests service providers based on asset type and location, allows user modification of Plans, allows user modification of service provider information, allows users to create their own Asset Plan, and allows users to share their created plan with the MFC community.

In an exemplary embodiment, People own and/or manage Assets and create, assign, create, and schedule To-Dos, Lists and Plans. People access a plurality of Dashboard screens such as the To-Dos Dashboard, Plans Dashboard, and Asset Dashboard to receive access to the data records associated with To-Dos, Plans and Assets respectively. In this embodiment, People may also behave like Assets in that People have ongoing scheduled events maintained and managed by the MFC system. Information records are maintained and managed regarding health and beauty appointments, information records (Will, DNR, Health record, homework assignments, sports statistics and schedules as well as custom records defined by a Family member as needed), and schedules. The People information required by the system may include email addresses, phone numbers, smart phone number and id, geographic location (zip code, latitude and longitude), Family id, login credentials and access permissions.

The MFC application provides views and access within the Family group regarding Assets, People and assigned To-Dos, People and Plans (including lists), permits Family members to create, schedule, assign and/or complete tasks, and allows user privacy within the Family group, such that one Family group member may not automatically view all records of other Family group members. The MFC application provides links between People and Information records, and permits the ability to store records, maintain history, and protect, modify, and remove information from Information records.

In an exemplary embodiment, Information records are files associated either with Assets or People. Information records may be created to manage and maintain information associated with wills, DNR orders, Health records, homework assignments, sports statistics and schedules, serial numbers, maintenance records, sales receipts, equipment manuals, and other information regarding household items of interest to family members. The MFC application provides links between People and Information records and provides the capability to store records, record history, and protect, modify and remove records and record information.

In an exemplary embodiment, To-Dos are actions that people perform and may include actions such as create/edit an action in a User View, create/edit an action in Asset View, assign an action to people including the time and location for performance of the action, move an action from one member of the Family group to another, pushing an action to the calendar, pushing an action to the notify process, and presenting a view of all actions to all members of the Family group. In this embodiment, the MFC application autoschedules actions based on calendaring, artificial intelligence, analytic information, and user preference, where the user preference permits selecting an easier management of time and location for an assigned family member. The MFC application may also suggest and autoschedule service providers based on urgency and/or user preference. For the purposes of autoscheduling To-Dos, the scheduling may be based upon family group and member behavior patterns, which may use an Artificial Intelligence (AI) engine to determine and schedule these actions. The MFC application may track and manage To-Dos on a visible number of To-Dos indicator or simply track the To-Dos in an internal counter.

In an exemplary embodiment, Plans are a collection of Lists and/or To-Dos that may be used for various activities including, in non-limiting examples, meals vacations, asset improvement, and transformational projects. Plan information required by the MFC application includes name of Family member, Optional To-Dos and list items such as grocery list, cooking dinner, invite guests, and other To-Do items, and budget and financial data. The MFC application may autogenerate templates for meal planning, home improvement project information, vacations, retirement, wedding, Do It Yourself automotive tune-ups, and pet ownership, among other activities and projects.

In an exemplary embodiment, an Announcement is information that is broadcast to the entire family at the same time. Non-limiting examples of such broadcast messages may include “Tonight dinner is chicken fried steak”, “I aced my test”, “I'm running late and can't pick up the dog from the vet.” The Announcement function requires text generated by a family group member. Announcements are broadcast to the entire family, each Announcement has a timestamp on messages generated and sent, sends notification alerts to family group members, and lets family group members who issued the Announcement know who has seen the Announcement.

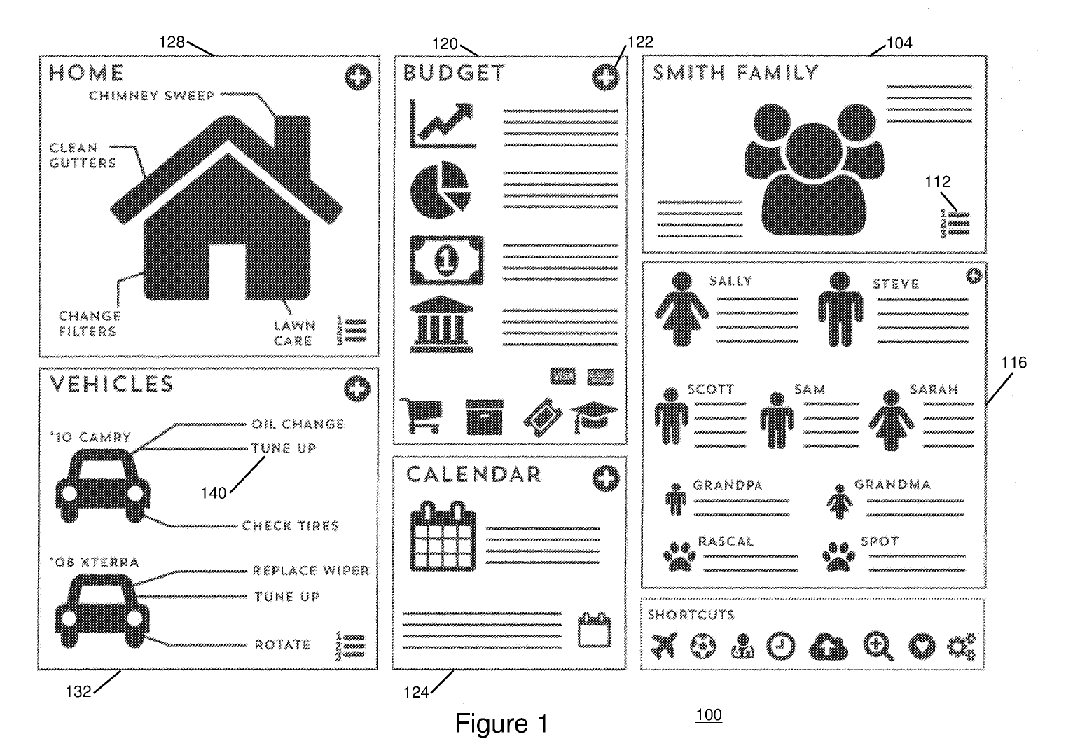

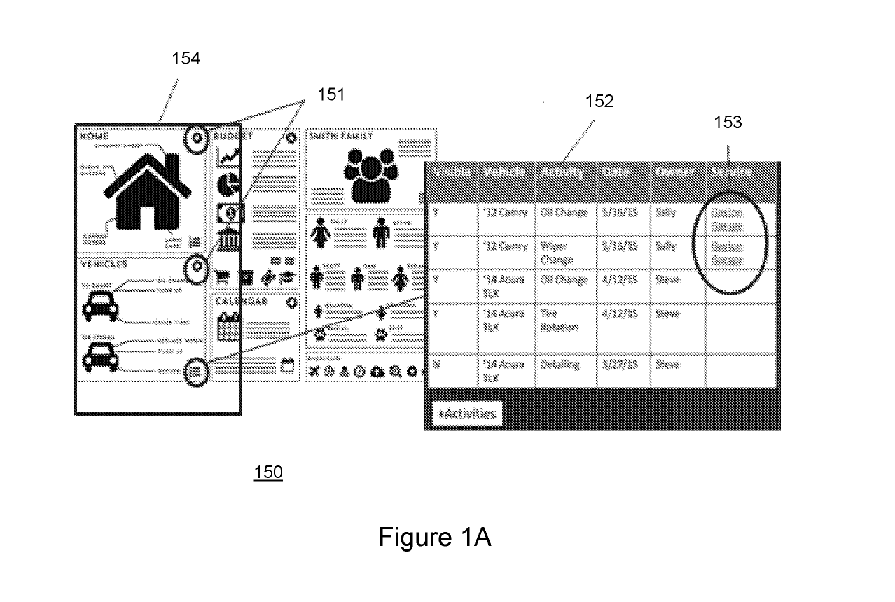

Turning now to FIG. 1, this figure presents a view of the My Family Cloud application dashboard consistent with certain embodiments of the present invention. The My Family Cloud application dashboard 100 display presents a group user, such as a family member, with options and functions available for selection. In an exemplary embodiment, the dashboard permits access to a family message board function 104. In this embodiment, icons, photos, caricatures, or other representations of each included member of the family are displayed 108 to provide selection capability for each family member. Additionally, an icon, photo, caricature or other display representation is present that is a representation of the family as a unit. In this particular display element, the element may be used to transmit information, instructions, notes, or any other communication to all members of the family.

The My Family Cloud application may also be connected to a mobile application such that all integrated features of the My Family Cloud application may be presented on a mobile device associated with a family member. In this fashion, all family members may access the integrated features of the My Family Cloud dashboard on a computer, internet computer, tablet, iPad, laptop, smart phone, or any other mobile device capable of supporting a mobile application. This integration of all devices having a display screen and an ability to connect to the My Family Cloud application over a network connection is a standard operating feature of the system.

In this embodiment, the family message board 104 display also presents three options 112 for communication and information interchange between family members. These options will be described more fully later. Selecting this display portion of the dashboard presents a full screen display of the family message board 104 with which a user or family member may interact. The family message board 104 provides access to communication capability between each member of the family and between all members of the family through the selection of the family display representation.

The My Family Cloud dashboard also presents a display of all members of the family unit 116. In an exemplary embodiment, each member of the family may be represented in this section of the dashboard, including family members, such as pets or family members who live remotely, who are not capable of communicating using the system due to lack of ability or lack of access. This dashboard section 116 presents a brief statement about each member of the family which may be a status or any other type of information the family decides is useful to display. The family display section of the dashboard 116 is configurable so as to keep the family member designations and explanations current and up-to-date.

The My Family Cloud dashboard 100 also present a display section dedicated to a snapshot view of the family Budget 120. The Budget display 120 presents a configurable set of information graphics and updates that present a snapshot view of the family budget in terms that are most of interest to the family members. The Budget display 120 may also present the family members with the ability to click on icons or other display representations that may open additional status windows for information from bank accounts, credit card accounts, loan accounts, educational accounts, service accounts, or any other record or account that presents a financial status of interest to the family. Selecting the “more information” icon, represented by a cross centered in a circle 122, may replace the My Family Cloud dashboard 100 display with a more detailed Budget display for interaction with family members.

The My Family Cloud dashboard 100 also presents a display section dedicated to a calendar tool 124. The calendar tool 124 may be an integrated calendar tool that combines information from all family members and updates and tracks all scheduling information in a central scheduling database. The calendar tool 124 may also perform predictive scheduling actions through the interaction of the scheduling activity for all family members, pets, home, vehicles, rental properties, additional uncategorized assets, and any other scheduling activity designated as such by one or more family members. The calendar tool 124 portion of the My Family Cloud dashboard 100 may also permit the selection of a calendar view through the selection of a “more information” icon 126 located within the portion of the My Family Cloud dashboard 100 reserved for the calendar tool 124.

The My Family Cloud dashboard 100 also presents a display section dedicated to maintenance and other activities associated with property or home ownership 128. The home is the single biggest asset owned by the vast majority of families and maintenance of the structure and property associated with the structure is correspondingly important. The My Family Cloud dashboard 100 permits one or more family members to establish one time or repeating maintenance activities for the home or property 128 and have these maintenance activities reflected in the family calendar. The maintenance activities may be associated with a particular family member for tracking and oversight. Future maintenance activities may be predicted by the My Family Cloud scheduler module based upon activities that have been previously entered in the home database fields as having a recurring status. Additionally, the home scheduler may provide a list of known maintenance activities that are common to all such homes or properties as suggestions that may be placed on the integrated calendar automatically.

The My Family Cloud dashboard 100 also presents a display section dedicated to maintenance and other activities associated with automobiles or other vehicles owned by the family 132. Maintenance schedules for each type of vehicle may be uploaded to the My Family Cloud system to permit the system to automatically generate maintenance activity reminders on the shared family schedule. These reminders may be visible on the My Family Cloud dashboard 140. This visibility serves the busy family members who are concerned with ordering and following through on vehicle maintenance activities 140 to ensure that these actions are completed. Proper maintenance and scheduled repair permits the busy family to reduce downtime and arrange for transportation around any scheduled outage for a particular vehicle. The My Family Cloud vehicle section 132 also maintains a history of the activity associated with each vehicle such that when the time comes to sell or transfer the title to the vehicle, a complete electronic record of the maintenance and repair activity for each vehicle may be readily transferred to the new owner.

Turning now to FIG. 1A, the My Family Cloud dashboard 150 also presents a display section dedicated to maintenance and other activities associated with assets such as home ownership and vehicles. Assets need action/activities provided by people in the form of to-dos and have information records. The My Family Cloud dashboard 150 permits one or more family members to establish one time or repeating maintenance activities for the assets and have these maintenance activities reflected in the family calendar. The maintenance activities may be associated with a particular family member for tracking and oversight. The maintenance activities can be connected to a specified Service Provider such as a professional plumber, vet and mechanic 153. Future maintenance activities may be predicted by the My Family Cloud scheduler module based upon activities that have been previously entered in the assets database fields as having a recurring status. Informational records associated with the assets may be uploaded into the My Family Cloud database. These informational records along with a history of the activity associated with each asset such that when the time comes to sell or transfer the title of the asset, a complete electronic record of the maintenance and repair activity for each asset may be readily transferred to the new owner. The My Family Cloud dashboard 150 allows for duplication of assets maintenance activities to a like asset record 151, 152. Each individual asset may be represented by a graphical depiction that may include a photograph, caricature, symbol, emoticon, or any other graphical depiction intended to represent that asset. In a non-limiting example, a photograph of each asset is present on the dashboard. When selected, the photograph of any asset will serve as a link to the task list for that asset.

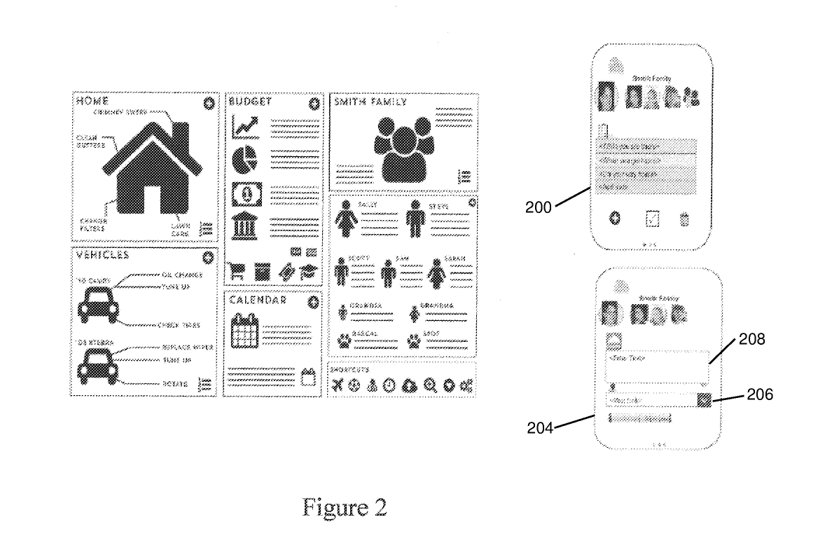

Turning now to FIG. 2, this figure presents a view of a display of the My Family Cloud application on a mobile device consistent with certain embodiments of the present invention. In an exemplary embodiment, the My Family Cloud system provides for complete integration with all devices, including mobile devices that have a processor and are capable of displaying graphical information and of creating and maintaining a networked communication channel with a cloud-based server. Such devices may include, but are not limited to laptops, internet computers, tablets, smart phones, iPads, internet capable watches, and any other device that may connect to the cloud-based My Family Cloud system. In this embodiment, a display 200 may be presented to a user when first connecting to the system through the network communication channel established through a web application installed on a mobile device. The mobile device display 200 presents a family member with a family message board display and permits the family member to review the task list, dinner options, and shopping list established for the day. Family members may also select a communication icon to present a data entry screen 204 for communication back to the other family members. The data entry screen 204 permits the identification of family members to whom messages are to be sent 206, including a message to all family members, and a text entry window 208 into which a family member may input message text that is then transmitted to the My Family Cloud system and distributed to the identified family member(s).

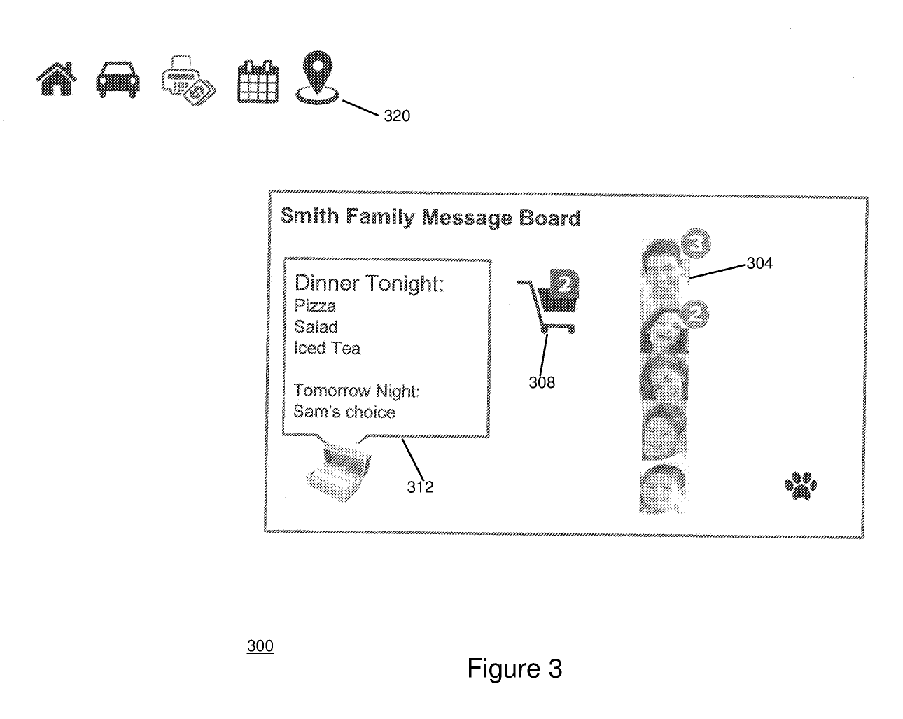

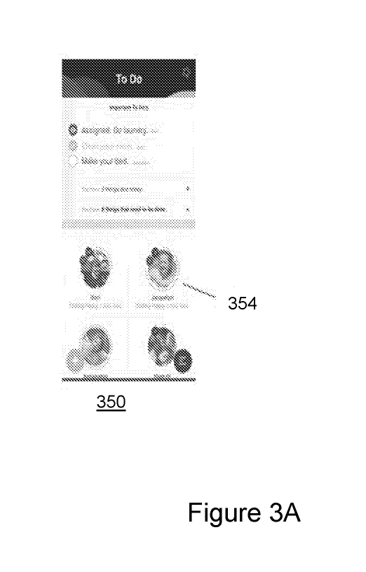

Turning now to FIG. 3, this figure presents a view of the family message board initial display consistent with certain embodiments of the present invention. Each family member may log into the system either through a browser interface on a browser capable computer system, or through a mobile application on a mobile devices. In an embodiment, a more detailed screen display may be presented on the larger surface area of a browser capable computer. In this embodiment, the family message board display 300 may present a view of all individual members of the family 304. These individuals are input to the system during setup for each family and may be updated as necessary through an administration function of the My Family Cloud system (not shown). Each individual member 304 may be represented by a graphical depiction that may include a photograph, caricature, symbol, emoticon, or any other graphical depiction intended to represent that family member. In a non-limiting example, a photograph of each family member 304 is present on the family message board display 300. When selected, the photograph of any family member 304 will serve as a link to the task list for that family member. Additionally, the My Family Cloud display 300 may provide a photograph or other graphical representation 304 that is representative of the family as an entity. Selecting the family entity photograph or graphic representation 304 may present a view of the integrated task list containing all tasks entered and assigned to each family member.

The family message board display 300 may also provide a display element that, when selected, will serve as a link to a shopping list 308. The shopping list may contain items to be purchased at a grocery store or any other items a family member may add to the shopping list 308. The shopping list 308 may be curated by one family member, such as the head of household, so as to permit only items considered necessary, or items the curator approves, to be added to the shopping list.

The family message board display 300 may also provide a display element that, when selected, serves as a link to a display of the menu for dinner on any particular day 312. The menu display may also include other indications for meal planning on current or subsequent days based upon the setup parameters established for this display. The menu 312 will be fully integrated with the shopping list 308 to provide entries into the shopping list 308 for items that should be purchased to permit the creation of the dinner menu 312. The curator of the shopping list 308 may decide upon items to be purchased based upon existing inventory and other conditions. The curator of the shopping list 308 may also assign the task of shopping to another family member by placing a request for that family member on the task list.

The family message board display 300 may also provide icons for additional functions. Each icon 320 may be attached to a link that will permit navigation to another function when the icon 320 is selected. In a non-limiting example, icons 320 may be present that permit links to the home, automobile, budget, calendar, and family member location functions. Other functions, represented by additional icons, may also be presented on the family message board display 300. The additional icons may be created during the initial setup of the My Family Cloud system, or they may be added at later times by an administrator of the My Family Cloud system.

Turning now to FIG. 3A, this figure presents a view of the family message board To-Do list display consistent with certain embodiments of the present invention. In an embodiment, the My Family Cloud system presents To-Do lists 350 to each member of a family group. A list of important To-Dos may be presented as the upper portion of the display. Each member of a family group may be represented by an icon, photo, or other representation 354 along with indicators, such as, but not limited to, numbers, letters, symbols, or other indicators, that are associated with To-Dos that are assigned to that family group member. The indicators may change as To-Dos are added or removed from the list, or as To-Dos are transferred from one family group member to another family group member. Additionally, indicators may be added to family group members as they take on the responsibility for To-Dos on their own initiative.

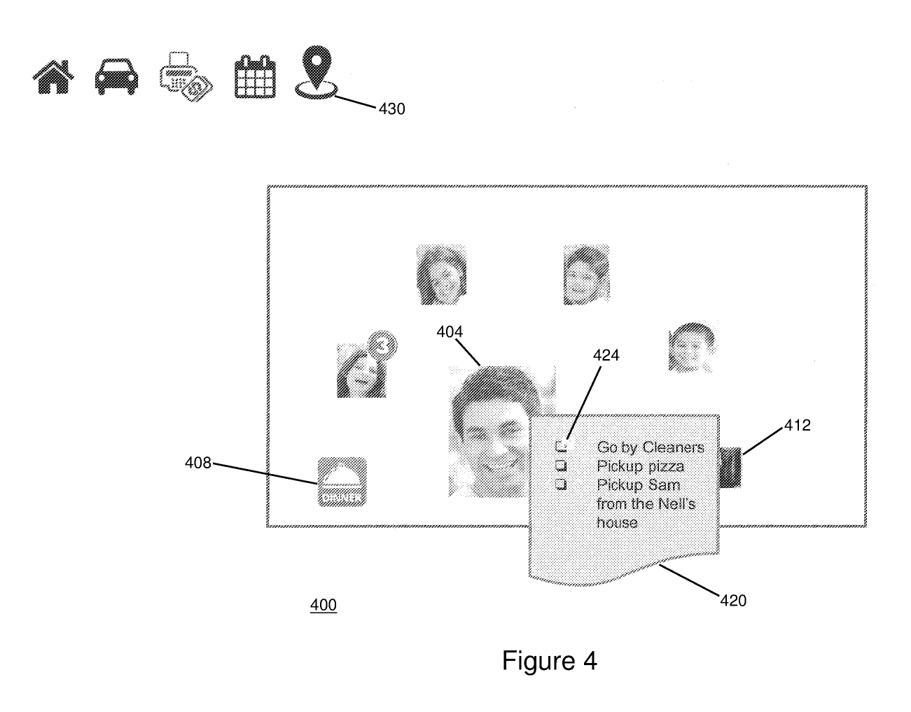

Turning now to FIG. 4, this figure presents a view of the family message board individual task list display consistent with certain embodiments of the present invention. In an exemplary embodiment, a family member may select the family section of the My Family Cloud dashboard to display the family task list 400. The family task list 400 displays a graphic representation of each family member associated with the family 404. The family task list 400 may also display icons that represent the “what's for dinner” function 408 and the shopping list function 412 for convenient access by the family members. In a non-limiting example, each family member may be represented by a photograph 404.

In an embodiment, upon selection of the photograph of a family member, the family task list 400 may display the task list 420 associated with that family member. The task list 420 presents the tasks that the family member is expected to complete. The completion time period may be flexible and may be established as a base parameter during setup of the My Family Cloud system. In a non-limiting example, the completion time period may be set to one day. In this non-limiting example, the items on the task list 420 for that family member are expected to be completed within a one day time period. A new task list may be presented the next day. Additionally, any tasks that were not completed in the initial time period may be retained such that they appear on the task list for the next time period. When a family member has completed a task on the task list 420, the family member may select the completion box 424 to indicate the completion of the task. When selected, an indication of a completed task will be displayed in the completion box 424. In a non-limiting example, this completion indicator may be a check mark, “x”, or any other indication that is chosen by the family to indicate the task has been completed.

The family task list display 400 may also provide icons for additional functions. Each icon 430 may be attached to a link that will permit navigation to another function when the icon 430 is selected. In a non-limiting example, icons 430 may be present that permit links to the home, automobile, budget, calendar, and family member location functions. Other functions, represented by additional icons, may also be presented on the family task list display 400.

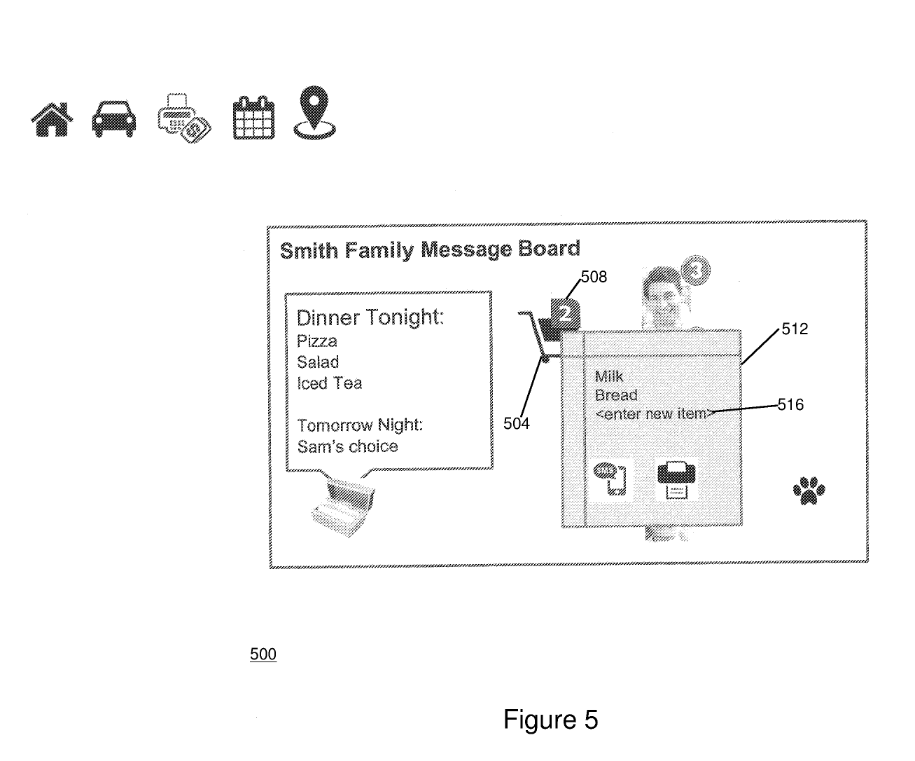

Turning now to FIG. 5, this figure presents a view of the family message board menu and shopping list components consistent with certain embodiments of the present invention. In an exemplary embodiment, the family message board display 500 may present a shopping list option 504 for selection by a family member. The shopping list option 504 may indicate that new items have been added to the shopping list 504. The indication of new items may take the form of a white number on a dark background 508 that partially overlays the shopping list 504. When a family member sees this new item indicator 508 they may review the shopping list 504 by selecting the shopping list icon 504. Upon selecting the shopping list icon 504, the family message board display 500 will be updated with a detailed list of items 512 on the shopping list 504 as an overlay on the display.

In an exemplary embodiment, the detailed list of items 512 presents the family member who selected the shopping list icon 504 with an itemized list of items that need to be acquired. The shopping list may be printed such that the family member who selected the shopping list may take the printed list with them when running errands or shopping for the particular items on the list. In an alternative embodiment, the shopping list may be sent to the family member from the My Family Cloud system database via SMS text messaging, or the list may be transmitted as an email message in standard email formats to permit the family member to forward the shopping list to another individual via email message. The family member may choose to go to a store, such as a grocery store, and shop for the items on the detailed list of items 512. Alternatively, the family member may have selected the shopping list icon 504 to add items to the detailed shopping list 512. A text entry area 516 may permit the family member to enter text for items that need to be purchased on behalf of the family or the family member. Upon entering the text, the family member may press an enter key to have the newly entered items added to the detailed shopping list 512. Additionally, the detailed shopping list 512 may have icons to permit the formatting and transmission of an SMS text message 520 or permitting the list to be printed 524, as previously described. The print icon 524 may format and transmit the detailed shopping list when the computer or other device is within connection range of an identified printer. When the My Family Cloud system determines that a printer is within range of the device and the printer is capable of interacting with the My Family Cloud system, the family member may select the print icon 524 and the detailed shopping list 512 will be transmitted to the printer for printing.

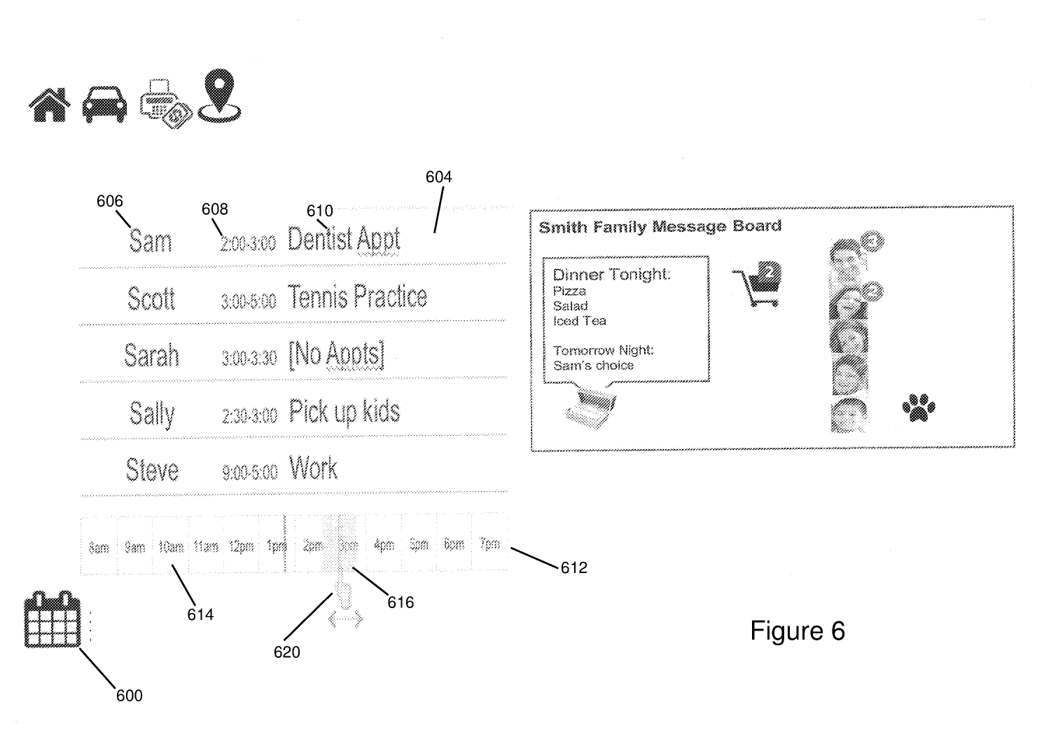

Turning now to FIG. 6, this figure presents a view of the calendar and slider components consistent with certain embodiments of the present invention. In an exemplary embodiment the integrated family calendar icon 600 may present a display of all scheduled appointments for each member of the family 604. The appointment schedule display 604 may be displayed by selecting the calendar icon 600 in the icon list on the display. The appointment schedule display 604 may display all appointments for each family member for particular time periods. In a non-limiting example, the appointment time period may be set to show appointments at each hour of the day. The appointment schedule display 604 may be configured to display the family member identifier 606, such as name, the time period for which the appointment is relevant 608, and the identifier of the type of appointment 610. In a non-limiting example, if there is no appointment for that family member 606 at the time period 608, the appointment identifier 610 may simply display a text message indicated that there are no appointments scheduled.

In an exemplary embodiment, associated with the appointment schedule display 604 the display may present a display element that permits the family member to navigate to other time periods to review scheduled appointments for each family member. The display element may take the form of a slider bar 612. In a non-limiting example, the slider bar 612 may display a pre-configured number of time periods 614 and a visual indicator 616 to indicate the time period 614 for which family appointments are presented in the appoint schedule display 604. Associated with the slider bar 612 the display may present a visual selector element 620 to indicate movement along the slider bar 612. This visual selector element 620 may take the form of an icon to be selected to foster movement along the time periods 614 displayed on the slider bar 612. Upon selecting the visual selector element 620 the family member may change the displayed time period by moving the visual selector element 620 to the left and the right. In a non-limiting example, the movement of the visual selector element 620 to the left may present scheduled appointments for time periods previous to the currently displayed appointments for all family members, and movement of the visual selector element 620 to the right may present scheduled appointments for time periods later than the currently displayed appointments for all family members. Any time period may be pre-configured as the granularity for the appointment schedule time period and the visual selector element 620 may be configured to move in directions other that left and right to indicate the movement from one selected time period to another selected time period display.

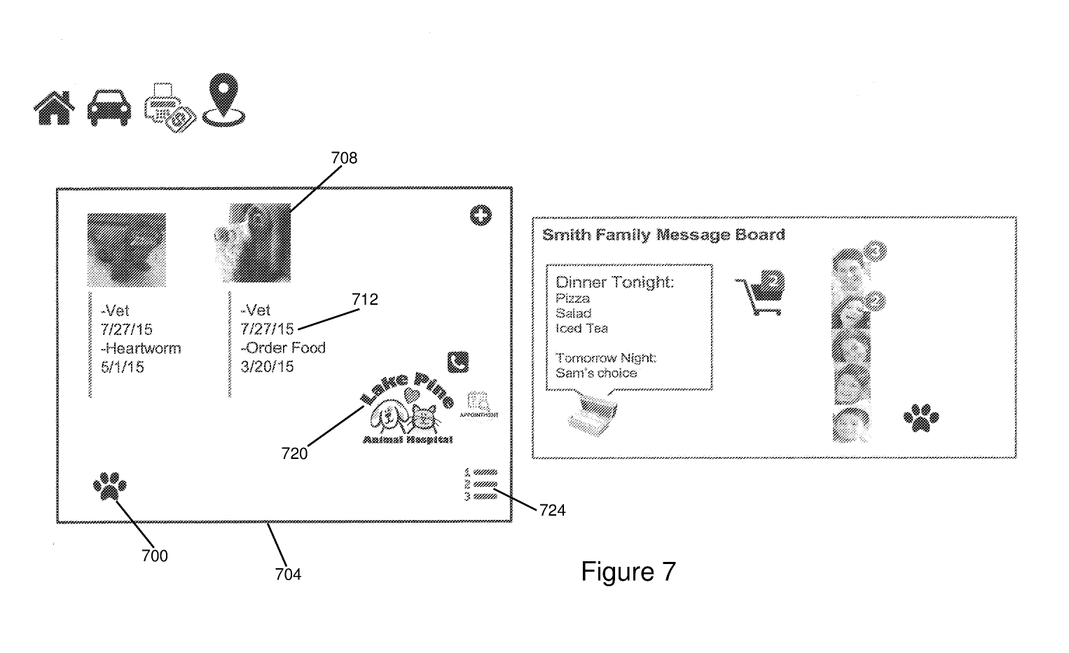

Turning now to FIG. 7, this figure presents a view of the pet schedule information display connector adaptor consistent with certain embodiments of the present invention. A family member may review select the pet information display icon 700 to review a display of information about any pets that are configured as part of the family. The pet information display 704 presents a graphical representation of each pet 708. The pet information may include scheduled events for each pet 712. Additional pet information displayed may include the name and contact information for the veterinarian/pet hospital 720 providing care for the pets. In a non-limiting example, the pet information display 704 may present an icon 724 that, when selected, will open a more detailed pet record for each pet to provide more information for each family pet.

In an exemplary embodiment, vet records for visits to the vet for each pet may be transmitted from the veterinarian to the My Family Cloud database. The vet records provide historical information on all past visits. In addition, the My Family Cloud may automatically schedule upcoming visits to the vet for each pet based upon information regarding the pet or on vet recommendations. The scheduled visits may then be inserted into the integrated family calendar and schedule. The pet information may be integrated into the My Family Cloud database records for the family with whom the pets are associated.

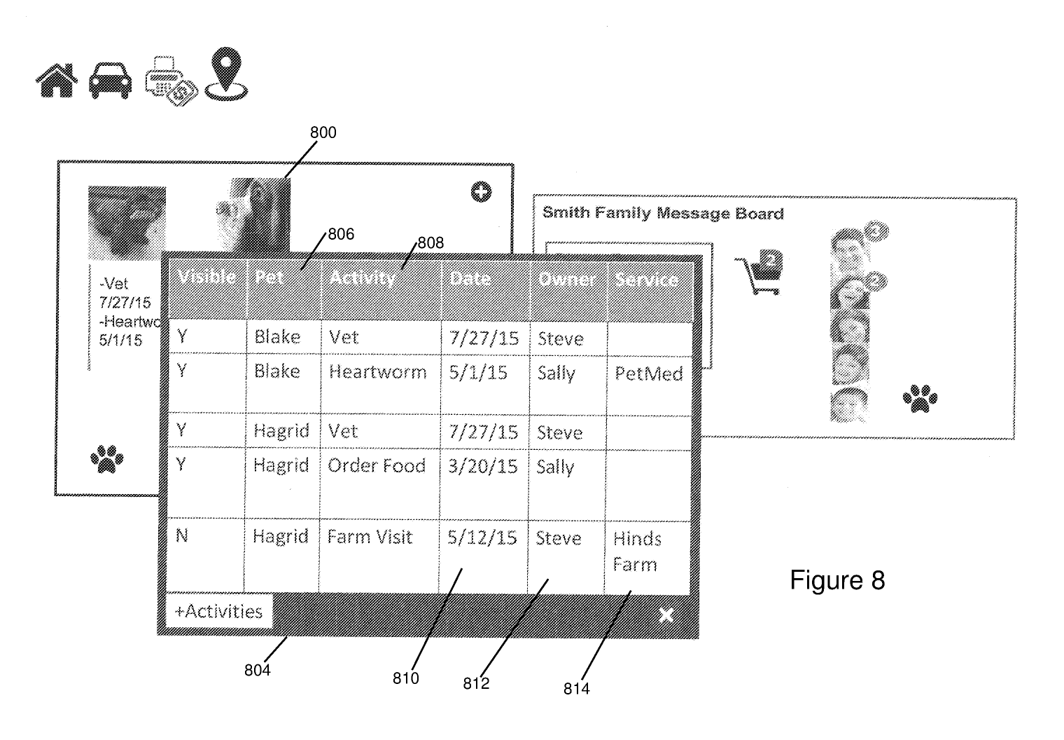

Turning now to FIG. 8, this figure presents a view of the pet information record display consistent with certain embodiments of the present invention. In an exemplary embodiment, the pet information display presented in FIG. 7 may provide an expansion of detailed information for each pet. Upon selection of the graphic representation of the pet 800, the family member is presented with a detailed information display for that selected pet 800. The detailed pet record 804 may provide the family member with pre-configured detail information including, but not limited to, the name of the pet 806, the activity most recently associated with the pet 808, a date of when the most recent pet activity has been, or will be, performed 810, the family member who is most closely associated with the pet 812, and the name of any service provider associated with the selected pet 814. Additional fields of data may be added to the display based upon additional information required by the family, or activities associated with the pet for which the family may need information or reminders.

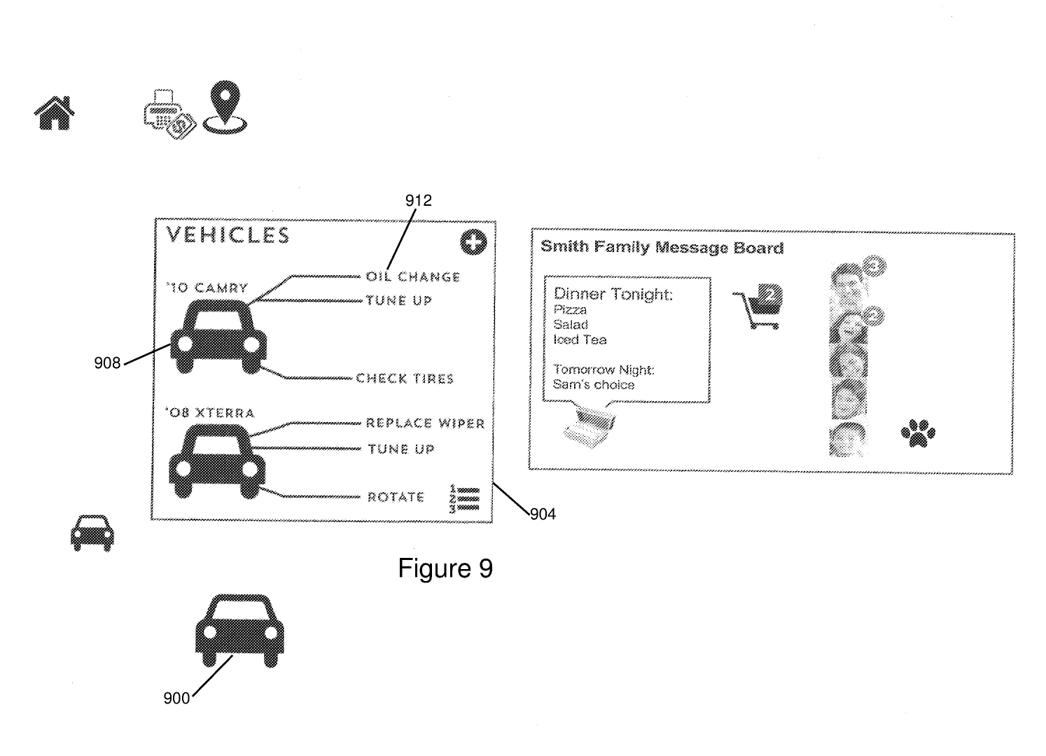

Turning now to FIG. 9, this figure presents a view of the automobile information record display consistent with certain embodiments of the present invention. In an exemplary embodiment, data associated with one or more vehicles may be displayed upon selection of the vehicle icon 900. Upon selection of the vehicle icon 900, a family member will be presented with a detailed vehicle display 904. The detailed vehicle display 904 may contain a listing of all vehicles associated with the family group 908. The list of vehicles 908 may present information associated with cars, trucks, motorcycles, boats, trailers, RVs, or any other vehicle the about which the family may wish to accumulate and manage records and information. Such records and other information may include, but is not limited to, purchase records, maintenance records, scheduled repairs and maintenance, titles, and any other records that may pertain to each vehicle in the list of vehicles 908. In a non-limiting example, the vehicle display may present upcoming maintenance activities required for each vehicle 912. Those maintenance activities that are repetitive or occur on an ongoing basis may be automatically added to the integrated family schedule maintained by the My Family Cloud application, such that family members are freed from the necessity of entering such recurring scheduled activities manually. The accumulated maintenance and repair record may be exported as a complete record and transferred to another individual when a vehicle is sold or otherwise removed from the list of vehicles 908.

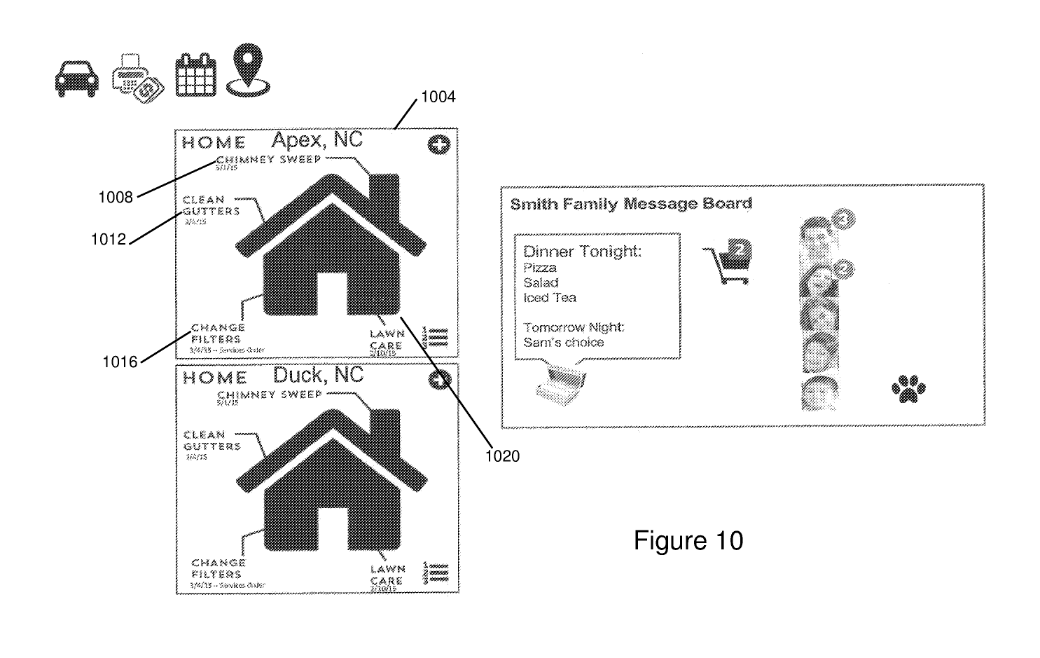

Turning now to FIG. 10, this figure presents a view of the home information record display consistent with certain embodiments of the present invention. In an exemplary embodiment, data associated with one or more vehicles may be displayed upon selection of the home icon. The selection of the home icon presents a display of a list of all homes 1004 associated with the family. The My Family Cloud system maintains and manages the record of all transaction, repairs and routine maintenance associated with each home in the list. In a non-limiting example, for a home located in Apex, NC the family may insert records for recurring chimney sweep 1008, gutter cleaning 1012, filter changing 1016, lawn maintenance 1020 actions. These recurring actions will be automatically inserted into the consolidated family schedule updated and maintained by the My Family Cloud system. The scheduling record added by the My Family Cloud system may contain information about the action to be taken, the date and time, and the service provider, if the action is to be performed by a non-family member. Again, the My Family Cloud system relieves family members from having to enter these recurring home maintenance activities into an integrated schedule manually.

While certain illustrative embodiments have been described, it is evident that many alternatives, modifications, permutations and variations will become apparent to those skilled in the art in light of the foregoing description.

What is claimed is:

1. A system, comprising:
a server having one or more processors;
the server having one or more electronic databases;
a scheduling module operative to automatically create date and time calendar entries for members of a family based upon one time and recurring activities associated with all family members;
a storage module for placing all scheduling activities within one or more electronic databases maintained on the server;
a messaging module operative to format and transmit messages, schedules, and other information to family members for display on desktop or mobile devices associated with each family member.

2. The system of claim 1, further comprising a software module for managing tasks to be added, updated, transferred, and/or deleted as To-Dos for family group members.

3. The system of claim 2, where the To-Dos are associated with one or more particular family group members.

4. The system of claim 1, further comprising a software module for scheduling To-Dos via calendar reminders, creating push and pull notifications for To-Dos, pushing tasks to one or more service providers, and managing information records associated with one or more To-Dos.

5. The system of claim 1, further comprising a software module for managing one or more Dashboard displays for To-Dos, Plans, Assets, and Announcements for a family group.

6. The system of claim 1, further comprising a software module for managing and maintaining a plurality of scheduled events and information records for each family group member.

7. The system of claim 6, further comprising a software module for establishing and maintaining links between family group members and scheduled events and information records for each family group member.

8. The system of claim 1, further comprising a software module for establishing, maintaining, and automatically generating plans as a collection of one or more lists and/or To-Dos associated with family assets or group members.

9. The system of claim 1, further comprising a software module for automatically generating and broadcasting announcements to members of the family group, either individually or in any combination of family group members, including the entire family group.

10. The system of claim 1, further comprising a software module for creating and displaying reports having asset activities and asset service providers presented in a concise format to one or more family group members for information and action.

11. A process for communication and coordination among a family group, comprising:
automatically creating and scheduling date and time calendar entries for members of a family based upon one time and recurring activities associated with all family members;
placing all scheduling activities within one or more electronic databases maintained on the server;
formatting and transmitting messages, schedules, and other information to family members for display on desktop or mobile devices associated with each family member.

12. The process of claim 11, further comprising a software module for managing tasks to be added, updated, transferred, and/or deleted as To-Dos for family group members.

13. The process of claim 12, where the To-Dos are associated with one or more particular family group members.

14. The process of claim 11, further comprising a software module for scheduling To-Dos via calendar reminders, creating push and pull notifications for To-Dos, pushing tasks to one or more service providers, and managing information records associated with one or more To-Dos.

15. The process of claim 11, further comprising a software module for managing one or more Dashboard displays for To-Dos, Plans, Assets, and Announcements for a family group.

16. The process of claim 11, further comprising a software module for managing and maintaining a plurality of scheduled events and information records for each family group member.

17. The process of claim 16, further comprising a software module for establishing and maintaining links between family group members and scheduled events and information records for each family group member.

18. The process of claim 11, further comprising a software module for establishing, maintaining, and automatically generating plans as a collection of one or more lists and/or To-Dos associated with family assets or group members.

19. The process of claim 11, further comprising a software module for automatically generating and broadcasting announcements to members of the family group, either individually or in any combination of family group members, including the entire family group.

20. The process of claim 11, further comprising a software module for creating and displaying reports having asset activities and asset service providers presented in a concise format to one or more family group members for information and action.
